(19) United States
(12) Patent Application Publication
(10) Pub. No.: US 2006/0209461 A1
(43) Pub. Date: Sep. 21, 2006

(54) Housing case for recording medium built-in cartridge, and cartridge built-in package using the same

(75) Inventors: Teruo Sogabe, Osaka (JP); Tsugihiro Doi, Osaka (JP)

Correspondence Address: BIRCH STEWART KOLASCH & BIRCH, PO BOX 747, FALLS CHURCH, VA, 22040-0747, US

(73) Assignee: HITACHI MAXELL, LTD.

(21) Appl. No.: 11/376,201

(22) Filed: Mar. 16, 2006

(30) Foreign Application Priority Data
Mar. 17, 2005 (JP) 2005-077579

(51) Int. Cl. G11B 23/02

(52) U.S. Cl. 360/132

(57) ABSTRACT

A housing case for a recording medium built-in cartridge of the present invention is for housing the recording medium built-in cartridge having an air vent. The housing case includes: a housing case body including a housing part and a lid part for opening and closing the housing part; and at least one humidity control member disposed in the housing case body and comprising at least one humidity control material that absorbs moisture in the housing case body when a humidity in the housing case body is a first humidity or higher and emits the moisture to the housing case body when the humidity in the housing case body is a second humidity or lower, the second humidity being lower than the first humidity.

### BACKGROUND OF THE INVENTION

1. Field of the Invention

The present invention relates to a housing case for recording medium built-in cartridge and a cartridge built-in package including a housing case and a recording medium built-in cartridge housed in the housing case.

2. Description of Related Art

A conventional housing case used for recording medium built-in cartridge is intended to protect the recording medium built-in cartridges from adverse effects such as a change in the external environment and impacts during the carrying and the storing. In order to prevent the intrusion of dust into the recording medium built-in cartridge, the housing case is configured to be capable of housing a recording medium built-in cartridge in an enclosed space when the case is closed, and is devised variously for keeping the airtightness of the inside.

Further, in order to avoid fatal breakage of the recording medium built-in cartridge due to a drop impact, a resin such as polypropylene, having a relatively high elasticity, is used for the material of the housing case.

Meanwhile, humidity is one of the major factors for degrading the properties of recording media such as magnetic tapes, magnetic disks and IC memory. If a recording medium built-in cartridge is kept for a long time in humid surroundings, the recording medium may erode or bacteria may propagate themselves. In recent years, ordinary housing has been improved in the air tightness, thus causing condensation easily. Recording medium built-in cartridges for general consumers are used and kept in such surroundings. Recording medium built-in cartridges for companies such as banks are required to have enhanced long-term storage capabilities than those required for products aimed at general consumers, so that they need to be kept in the surroundings where the humidity and the like are controlled. In practice, however, they rarely are kept in ideal surroundings.

In such a background, moisture exclusion devices for recording medium built-in cartridges or the like are disclosed. For instance, JP H07(1995)-242275 A discloses a moisture exclusion device provided with a desiccant such as silica gel housed in a case and a moisture permeable film provided at an opening of the case. This moisture exclusion device has approximately the same shape as that of a recording medium built-in cartridge (e.g., videotape cassette), and is kept in a housing rack together with recording medium built-in cartridges, thereby excluding the moisture from the recording medium built-in cartridges.

However, when the inside of the recording medium built-in cartridge is dried excessively, the characteristics of the recording medium are affected adversely. For example, in the instance of a tape cartridge including a case and a magnetic tape (recording medium) disposed in the case, a lubricant included in the magnetic tape may evaporate, thus degrading the magnetic tape.

Therefore, with the foregoing in mind, it is an object of the present invention to provide a housing case capable of keeping the humidity in a recording medium built-in cartridge within a predetermined range, and to provide a cartridge built-in package including such a housing case and a recording medium built-in cartridge housed in the housing case.

### SUMMARY OF THE INVENTION

A housing case for a recording medium built-in cartridge of the present invention is for housing the recording medium built-in cartridge having an air vent. The housing case includes: a housing case body including a housing part and a lid part for opening and closing the housing part; and at least one humidity control member disposed in the housing case body and comprising at least one humidity control material that absorbs moisture in the housing case body when a humidity in the housing case body is a first humidity or higher and emits the moisture to the housing case body when the humidity in the housing case body is a second humidity or lower, the second humidity being lower than the first humidity.

A cartridge built-in package of the present invention includes the housing case for a recording medium built-in cartridge of the present invention. In this cartridge built-in package, the recording medium built-in cartridge having the air vent is housed in the housing case.

These and other advantages of the present invention will become apparent to those skilled in the art upon reading and understanding the following detailed description with reference to the accompanying figures.

### BRIEF DESCRIPTION OF THE DRAWINGS

FIG. 1 is a plan view showing an exemplary housing case for recording medium built-in cartridge of the present embodiment when it is opened.

FIG. 2 is a cross-sectional view of the housing case for recording medium built-in cartridge of FIG. 1 taken along I-I′ of FIG. 1.

FIG. 3 is a cross-sectional view of the housing case for recording medium built-in cartridge of FIG. 1 taken along II-II′ of FIG. 1.

FIG. 4 is a perspective view of an exemplary recording medium built-in cartridge to be housed in the housing case for recording medium built-in cartridge of FIG. 1.

FIG. 5 is an enlarged cross-sectional view of the recording medium built-in cartridge of FIG. 4 taken along III-III′ of FIG. 4.

FIG. 6 schematically shows an exemplary humidity control member making up the housing case for recording medium built-in cartridge of the present embodiment.

FIG. 7 schematically shows another exemplary humidity control member making up the housing case for recording medium built-in cartridge of the present embodiment.

FIG. 8 is a cross-sectional view showing another exemplary housing case for recording medium built-in cartridge of the present embodiment when it is opened.

FIG. 9 is a cross-sectional view of a housing part of still another exemplary housing case for recording medium built-in cartridge of the present embodiment.

FIG. 10 is a partial cross-sectional view showing an exemplary cartridge built-in package of the present embodiment.

### DETAILED DESCRIPTION OF THE INVENTION

The following describes an exemplary housing case for recording medium built-in cartridge of the present invention and an exemplary cartridge built-in package using the same, with reference to the drawings.

(Embodiment 1)

In Embodiment 1, a housing case for tape cartridge is described as one example of the housing case for recording medium built-in cartridge (hereinafter simply called“housing case”) of the present invention.

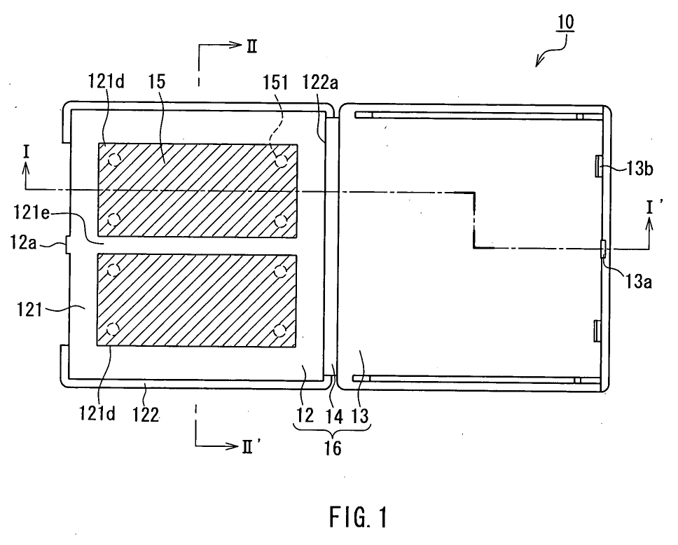

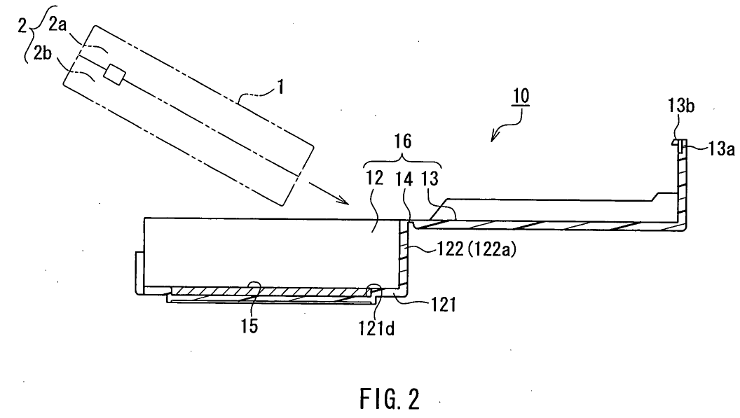

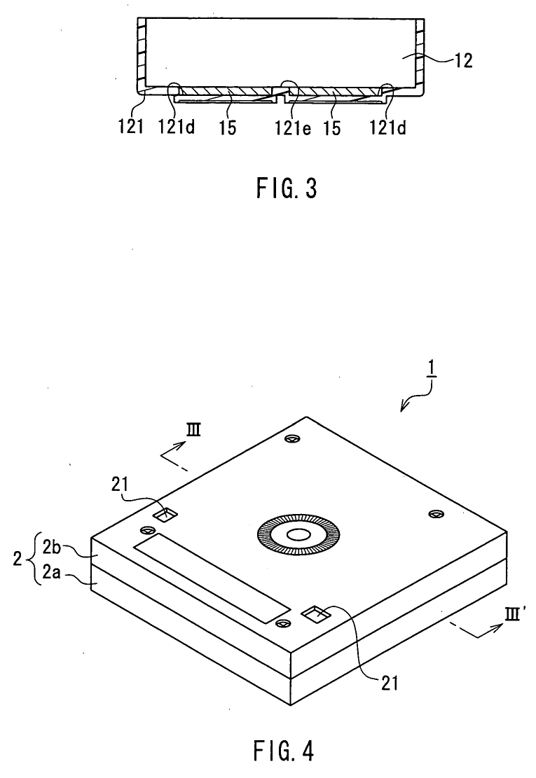

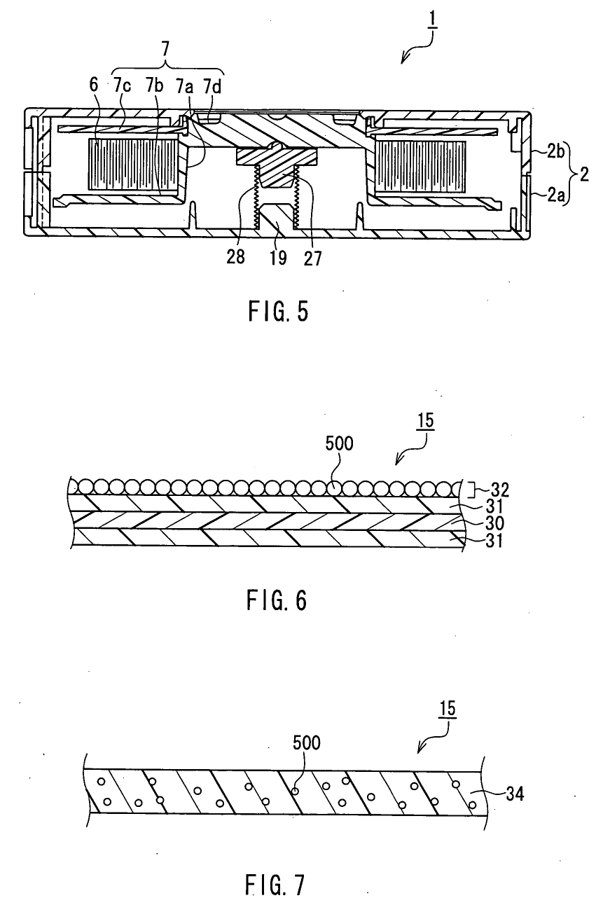

FIG. 1 is a plan view showing the housing case of the present embodiment when it is opened. FIG. 2 is a cross-sectional view of the housing case of FIG. 1 taken along I-I′ of FIG. 1 and FIG. 3 is a cross-sectional view of the housing case of FIG. 1 taken along II-II′ of FIG. 1. FIG. 4 is a perspective view of a recording medium built-in cartridge (hereinafter this may be called “cartridge” simply) to be housed in the housing case of FIG. 1, and FIG. 5 is a cross-sectional view of the cartridge of FIG. 4 taken along III-III′ of FIG. 4. Note here that in FIG. 1 a humidity control member 15 is illustrated with hatching.

The housing case of the present embodiment of FIG. 1 is a housing case 10 for housing a cartridge 1 as shown in FIG. 2. As shown in FIG. 1 and FIG. 2, the housing case 10 includes a housing case body 16 and the at least one humidity control member 15 disposed in the housing case body 16, the housing case body 16 being provided with a housing part 12 and a lid part 13 for opening/closing the housing part 12. The humidity control member 15 includes at least one humidity control material. Herein, the humidity control material refers to a material having the function of adjusting humidity so that the material absorbs the moisture when the humidity (relative humidity) is high and emits the moisture when it becomes dry.

As shown in FIG. 1 and FIG. 2, the housing part 12 has a bottom plate 121 that is rectangular in the planar dimension and is slightly larger in size than that of the cartridge 1 to be housed and a plurality of side walls 122 rising from this bottom plate 121. The housing part 12 is formed so as to let the cartridge 1 fit therein substantially.

The housing case body 16 is provided with a hinge part 14 allowing the lid part 13 to be coupled with the housing part 12 so as to open and close the housing part 12. When the lid part 13 of the housing case 10 is overlaid on the housing part 12, an engagement groove 13a and an engagement projection 12a engage with each other, and an engagement protrusion 13b engages with the bottom face of the housing part 12. Thereby, the housing case 10 can be kept in the closed state.

As shown in FIG. 2, a portion of the housing part 12 opposed to the side wall 122a coupled with the lid part 13 via the hinge part 14 has an opening. Thus, the cartridge 1 can be housed while moving along the bottom plate 121 of the housing part 12, i.e., by sliding the cartridge 1 on the bottom plate 121.

In the example shown in FIGS. 1 through 3, the humidity control member 15 is secured to the bottom plate 121 of the housing part 12. The humidity control member 15 as a whole can be formed of at least one humidity control material, or at least a principal face opposite to the principal face on the bottom-plate 121 side may include at least one humidity control material.

As shown in FIG. 5, the recording medium built-in cartridge 1 to be housed in the housing case of the present embodiment is provided with a case 2 and a magnetic tape 6 housed in the case 2. The case 2 is formed so that a first container 2a and a second container 2b are aligned to form an internal space therebetween and are fastened by screws or the like.

Note here that FIG. 4 and FIG. 5 show the state where the first container 2a is below the second container 2b for convenience in explanations. However, during the normal operation, the first container 2a is used above the second container 2b.

The magnetic tape 6 is wound around a reel 7 that is rotatably housed in the case 2, and the magnetic tape 6 can be unreeled from the reel 7 and pulled out of the case 2 through an opening (not illustrated) of the case 2. At the unreeling end of the magnetic tape 6, a lead made of metal (not illustrated) is secured, and when the tape cartridge is loaded in a drive, the lead is captured by a connection device of the drive. The case 2 has air vents 21 (see FIG. 4) for enabling the communication between the inside and the outside of the case 2. The air vents 21 may be one provided for the purpose of the engagement with the drive or the identification by the drive, or may be provided separately from them.

In the case 2, the reel 7 is pressed and biased upwardly in FIG. 5 by an elastic body like a spring such as a compression coil spring 28 or the like that acts via a shaft 27. Thereby, the reel 7 can be prevented from rotating freely during the non-operating state. Note here that a guide projection 19 is provided substantially at the center of the bottom portion of the first container 2a, the guide projection 19 having the outer diameter smaller than the inner diameter of the compression coil spring 28. This guide projection 19 is inserted into a bore of the compression coil spring 28, whereby the displacement of the compression coil spring 28 can be suppressed.

The reel 7 has a shaft part 7a around which the magnetic tape 6 is wound, a disk-shaped first flange 7b formed integrally with the shaft part 7a and a second flange 7c melted to be secured to the shaft part 7a. The shaft part 7a is in a substantially cylindrical shape with bottom and has a cavity therein. The outer surface of the bottom part of the shaft part 7a is provided with an engagement gear 7d capable of engaging with a gear (not illustrated) of a driving shaft of the drive. The outer surface of the bottom part of the shaft part 7a is exposed to the outside of the case 2 through an opening of the bottom part of the second container 2b. The reel 7 rotates with the engagement gear 7d engaging with the driving gear of the driving shaft of the drive that is inserted into the case 2 through this opening. When the reel 7 rotates, the tape 6 is wound around the reel 7 or unreeled from the reel 7.

The humidity control material contained in the humidity control member 15 absorbs the moisture in the housing case body 16 when the humidity in the housing case body 16 is a first humidity or higher, and emits the moisture to the housing case body 16 when the humidity in the housing case body 16 is a second humidity or lower, the second humidity being lower than the first humidity (see FIG. 1 and FIG. 2).

As shown in FIG. 4, the case 2 making up the cartridge 1 has the air vents 21 enabling the communication between the inside and the outside of the case 2. Thus, the communication of the air through the case 2 is performed via the air vents 21. Therefore, when the cartridge 1 housed in the housing case 10 is stored, the humidity in the cartridge 1 becomes closer to the humidity in the housing case 10, and finally becomes equal to that.

That is to say, when the humidity in the housing case 10 or the humidity in the housing case 10 and the cartridge 1 changes with a change of the humidity in the storage surroundings, the humidity control member 15 absorbs or emits the moisture, whereby the humidity in the housing case 10 and in the case 2 can be kept always within a predetermined range.

In this way, with the use of the housing case 10 of the present embodiment, the humidity in the case 2 of the cartridge 1 can be kept within a predetermined range. Thereby, the degradation of the magnetic tape 6 due to a change of the humidity in the case 2 can be suppressed, and therefore the reliability of the cartridge 1 can be enhanced.

The temperature in the housing case 10 changes depending on the temperature of the storage surroundings of the housing case 10. The temperature of the storage surroundings of the housing case 10 normally ranges from 10° C. to 60° C. The preferable humidity in this temperature range with consideration given to the moisture resistance of the magnetic tape 6 or the like is more than 30% and less than 90%, and more preferably more than 40% and less than 80%. Therefore, the first humidity where the absorption of the moisture by the humidity control material takes place preferably is a predetermined humidity within the range from 70% to 90%, for example, and the second humidity where the emission of the moisture by the humidity control material takes place is a predetermined humidity within the range from 30% to 50%. More preferably, the first humidity is 80% and the second humidity is 40%. Note here that the above-stated humidity is measured using ST-4 (round type, 4.5 cm) produced by Shinwa Rules Co., Ltd.

As the humidity control material, at least one type of porous material selected from the group consisting of B-type silica gel (specified in JIS Z 0701), diatomaceous earth, sepiolite, zeolite, coal ash, porous ceramics, charcoal and ultrahigh molecular weight polyethylene preferably is used, for example. Among them, diatomaceous earth, which can absorb the most moisture and is excellent in responsivity for the absorption and emission of the moisture in accordance with the humidity change in the housing case body 16, is preferable. The diatomaceous earth is not limited especially as to type, and Wakkanai diatomaceous earth whose pore diameter is 4 nm to 20 nm is preferable.

The Wakkanai diatomaceous earth includes the following components:

| | |
|---|---|
| SiO₂ | 79.47% |
| Al₂O₃ | 8.63% |
| Fe₂O₃ | 1.80% |
| TiO₂ | 0.32% |
| CaO | 0.24% |
| MgO | 0.87% |
| Na₂O | 0.66% |
| K₂O | 1.45% |
| P₂O₂ | 0.04% |

The B-type silica gel has a property of absorbing the moisture rapidly in an environment of high humidity and emitting the absorbed moisture gradually in an environment of low humidity.

The porous ceramics include alumina, zirconia, silicon nitride, silicon carbide and the like, for example, also exhibit the requisite properties and are suitable for use as the humidity control material.

Preferably, the ultrahigh molecular weight polyethylene includes one having a porous structure whose pore diameter is 10 nm or less, for example.

The amount of the at least one humidity control material contained in the humidity control member 15 is not limited especially, and this may be determined appropriately with consideration given to the capacity of the housing case 10, the capacity of the case 2 of the cartridge 1, the moisture absorption/emission properties of the humidity control material and the like. For instance, if the capacity of the housing case 10 is 300 to 900 cm³ and the capacity of the case 2 is 200 to 800 cm³, then the surface area of the humidity control member 15 effective for the humidity control preferably is 20 cm² to 200 cm². In this instance, if the Wakkanai diatomaceous earth is used as the humidity control material, the humidity control member 15 preferably contains 80 to 100 volume% of the Wakkanai diatomaceous earth.

This Wakkanai diatomaceous earth increases rapidly in the coefficient of the moisture absorption at the humidity of about 80% when the temperature is 10° C., and has a high coefficient of the moisture absorption at a high humidity. Therefore, the Wakkanai diatomaceous earth exhibits the moisture absorption function when the humidity in the housing case 10 is 80% or higher, and exhibits the moisture emission function when the humidity is 40% or lower. Further, similarly at the temperature of 60° C., the Wakkanai diatomaceous earth exhibits the moisture absorption function when the humidity in the housing case 10 is 80% or higher, and exhibits the moisture emission function when the humidity is 40% or lower. Although the moisture content in the air changes with a temperature, the moisture absorption/emission properties of the humidity control material themselves do not change. With the use of the humidity control member containing such diatomaceous earth as the humidity control material, the humidity in the housing case 10 and in the case 2 of the cartridge 1 can be kept within a range of more than 40% and less than 80% when the temperature ranges from 10° C. to 60° C.

When more than one humidity control material is used, the materials may be admixed or segregated.

The shape of the humidity control member 15 is not limited especially, and a shape enabling a larger surface area effective for the humidity control is preferable. For instance, a sheet form or a plate form, by which the surface area can be ensured easily, is preferable. The humidity control member 15 in the sheet form or the plate form is preferable also because it can be disposed in a limited space. As shown in FIG. 1, the humidity control member 15 is rectangular in the plan view. However, this is not the limiting example, and any shape such as circular or polygonal is possible.

As the humidity control member 15 in the sheet form, as shown in FIG. 6, a laminate including a base 30 provided with adhesive layers 31 on the both principal surfaces and a humidity control layer 32 formed on one of the adhesive layers 31 and containing the powder of the above-stated humidity control material 500 is available, for example. As in this example, the humidity control member 15 may be a laminate of two or more layers where the outermost layer on one side of the laminate is a humidity control layer 32 containing a humidity control material and the other outermost layer is an adhesive layer 31. This configuration is preferable because the humidity control member 15 can be secured to the housing case body 16 easily. As the base 30, a resin film may be used, for example, and as the material of the adhesive layer 31, an acrylic adhesive may be used, for example. The humidity control layer 32 may contain a binder resin or the like, if required, in addition to the humidity control material 500.

Further, as the humidity control member 15 in the sheet form, a sheet-form article made of a non-woven cloth 34 impregnated with the powder of the above-stated humidity control material 500 may be used, for example, as shown in FIG. 7. This sheet-form article can be obtained by immersing a non-woven cloth in a dispersion medium whereby the powder of the humidity control material 500 is dispersed within gaps between the fibers.

As the humidity control member 15 in the plate form, a molded body obtained by compression-molding of the powder of the humidity control member using gas or the like can be used. A laminate layer containing a resin may be provided on one principal surface of the molded body so as to enhance the strength of the molded body. Further, the humidity control member 15 may contain a binder resin or the like, if required, in addition to the humidity control material. As the binder resin, an epoxy resin may be used, for example.

The position of the humidity control member 15 within the housing case 10 is not limited especially, and preferably is disposed on the bottom plate 121 as shown in FIG. 1 through FIG. 3. With this configuration, a humidity control member 15 with a larger surface area effective for the humidity control can be used. Also, this configuration is preferable because the cartridge 1 often is housed in the housing case 10 so that the second container 2b side with the air vents 21 formed faces downward (see FIG. 2 and FIG. 4). However, as long as the humidity control member 15 is disposed in the housing case body 16, it may be secured to any one or multiple locations including the bottom plate 121, the side walls 122 and the lid part 13.

As shown in FIG. 1 or FIG. 2, the housing part 12 of the housing case body 16 may have a concavity or depression 121d so as to contain the humidity control member 15 therein. This configuration is preferable because of the smooth loading/unloading of the cartridge 1.

The humidity control member 15 can be secured to the housing case body 16 as follows. After the humidity control member 15 is disposed in a dye for molding the housing case body 16, the molding of the housing case body 16 may be performed by insert molding or the like. Needless to say, the method for securing the humidity control member 15 to the housing case body 16 is not limited to this, and other methods such as adhesion using an adhesive and ultrasonic welding may be used.

Although the entire face of the humidity control member 15 facing the housing case body (e.g., the bottom plate 121 ) may be secured to the housing case body, the face of the humidity control member 15 facing the housing case body may be bonded partially (at portions 151 ) to the housing case body (in this example, to the bottom plate 121 ), for example.

As shown in FIG. 3, the housing case 10 may be provided with a plurality of humidity control members 15. In this case, a plurality of concavities or depressions 121d are formed in the housing part 12, at the bottom plate 121, for example, and the humidity control members 15 preferably may be secured so as to be contained in the respective concavities or depressions 121d. It is preferable that the longitudinal direction of a convex portion 121e, which is formed as a result of the formation of the plurality of concavities or depressions 121d, is orthogonal to the longitudinal direction of the hinge part 14 (see FIG. 1). That is, as shown in FIG. 2, when the cartridge 1 is housed in the housing part 12 while sliding the corner of the cartridge 1 on the bottom plate 121 of the housing part 12, the traveling direction of the cartridge 1 preferably agrees with the longitudinal direction of the convex portion 121e (see FIG. 3). In this instance, the insertion of the cartridge 1 into the housing part 12 can be performed smoothly. Note here that the above “orthogonal” includes not only the strict orthogonal but also substantial orthogonal.

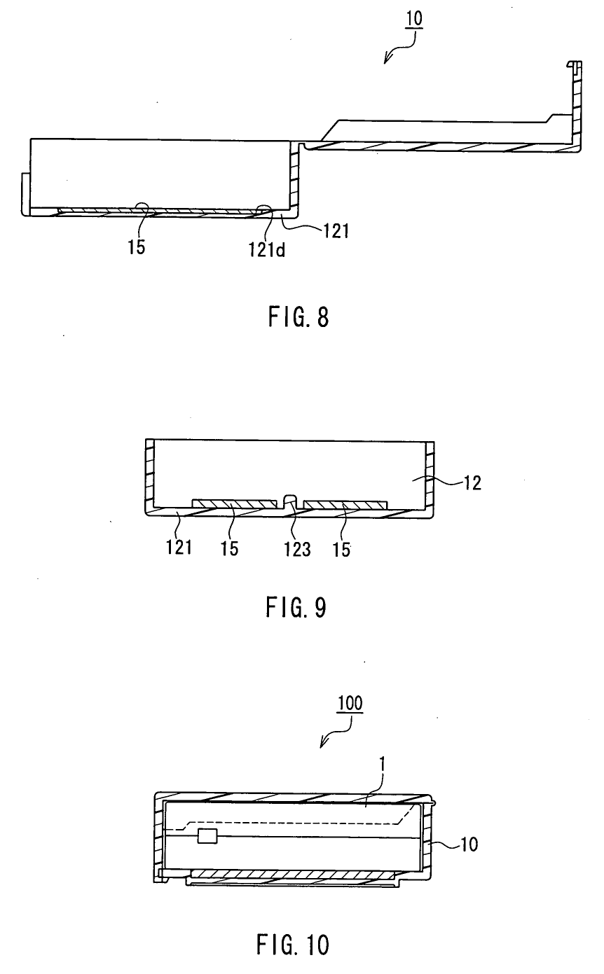

FIG. 8 shows another example of the housing case of the present embodiment. As shown in FIG. 8, the humidity control member 15 may be provided so as not to increase the thickness of the housing case 10 when it is closed and so as not to reduce the capacity of the housing case 10. In this instance, the housing efficiency of the housing case 10 per unit capacity in the library can be maintained. For instance, the maximum thickness of the bottom plate 121 is made equal to the thickness of the bottom plate making up the conventional housing case and the humidity control member 15 is disposed in a concavity or depression 121d that is deeper than the thickness of the humidity control member 15, whereby the housing case having the same thickness and the same capacity of the housing case 10 as those of the conventional one can be realized.

Note here that although the humidity control member(s) 15 is disposed in the one or more concavity or depression 121d in all of the examples shown in FIGS. 1 to 3 and 8, the housing case of the present embodiment is not limited to this. For instance, as shown in FIG. 9, a plurality of humidity control members 15 may be disposed on a flat bottom plate 121. In this instance, the housing case body preferably has a rib 123 that is higher than the thickness of the humidity control members 15, the rib 123 being disposed between the humidity control members 15. It is also preferable that, similarly to the convex portion 121e of FIG. 3, the longitudinal direction of the rib 123 be the same direction as the traveling direction of the cartridge 1 when the cartridge 1 is housed in the housing part 12 while sliding it on the bottom plate 121. With the presence of the rib 123 formed on the bottom plate 121, the insertion of the cartridge 1 into the housing part 12 can be performed smoothly.

The housing case 10 of the present embodiment may be provided with an indicator (not illustrated) whose color tone changes with a humidity change in the housing case body. The indicator preferably can be observed from the exterior of the housing case body. It can be confirmed by observing a change in the color tone of the indicator from the exterior of the housing case 10 as to whether the storage condition is appropriate or not.

The indicator is not limited especially, and commercially available one may be used. As an example of a commercially available indicator, a simplified humidity indicator card produced by Piatec cooperation is available.

The housing case body may be provided with a window for visual observation of the indicator. Alternatively, the housing case body partially or as a whole may be formed of a material having a high degree of transparency, so as to allow the indicator to be visually observed from the outside of the housing case 10.

In the present embodiment, the magnetic tape is exemplified for the description of the recording medium. However, in the present invention, the recording medium is not limited to the magnetic tape. The recording medium may be a magnetic disk, IC memory or the like, for example.

FIG. 10 shows an exemplary cartridge built-in package 100 where a cartridge 1 with air vents 21 (see FIG. 4) is housed in the housing case 10 of the present embodiment. The housing case 10 is in a substantially enclosed state, and the internal space is occupied by the cartridge 1 with very small room left therein.

As stated above, according to the present invention, a housing case for recording medium built-in cartridge capable of keeping the humidity in a recording medium built-in cartridge within a predetermined range, and such a cartridge built-in package can be provided.

According to the present invention, since the humidity in the cartridge can be kept within a predetermined range, the present invention is effective for a housing case for a cartridge provided with a recording medium such as a magnetic tape, a magnetic disk or IC memory

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A housing case for a recording medium built-in cartridge that houses the recording medium built-in cartridge having an air vent, comprising:
a housing case body including a housing part and a lid part for opening and closing the housing part; and
at least one humidity control member disposed in the housing case body and comprising at least one humidity control material that absorbs moisture in the housing case body when a humidity in the housing case body is a first humidity or higher and emits the moisture to the housing case body when the humidity in the housing case body is a second humidity or lower, the second humidity being lower than the first humidity.

2. The housing case for a recording medium built-in cartridge according to claim 1, wherein the humidity control material comprises at least one type of porous material selected from the group consisting of B-type silica gel, diatomaceous earth, sepiolite, zeolite, coal ash, porous ceramics, charcoal and ultrahigh molecular weight polyethylene.

3. The housing case for a recording medium built-in cartridge according to claim 1, wherein the humidity control material comprises diatomaceous earth.

4. The housing case for a recording medium built-in cartridge according to claim 1, wherein the humidity control member is in a sheet form or in a plate form.

5. The housing case for a recording medium built-in cartridge according to claim 1, wherein the first humidity is a predetermined humidity within a range from 70% to 90%, and the second humidity is a predetermined humidity within a range from 30% to 50%.

6. The housing case for a recording medium built-in cartridge according to claim 1, further comprising an indicator whose color tone changes with a humidity change in the housing case body,
wherein the indicator can be observed from the exterior of the housing case body.

7. The housing case for a recording medium built-in cartridge according to claim 1,
wherein a concavity is formed in a portion of the housing case body, and
the humidity control member is disposed so that the concavity contains the humidity control member.

8. The housing case for a recording medium built-in cartridge according to claim 1, comprising a plurality of the humidity control members.

9. The housing case for a recording medium built-in cartridge according to claim 8,
wherein a plurality of the concavities are formed in the housing case body, and
the plurality of humidity control members are disposed so that the plurality of concavities contain the respective humidity control members.

10. The housing case for a recording medium built-in cartridge according to claim 8,
wherein the housing case body comprises a rib that is higher than a thickness of the humidity control members, the rib being disposed between the plurality of humidity control members.

11. The housing case for a recording medium built-in cartridge according to claim 1, wherein the housing case body comprises a hinge part allowing the lid part to be coupled with the housing part so as to open and close the housing part.

12. The housing case for a recording medium built-in cartridge according to claim 11,
wherein the housing part comprises a bottom plate and a plurality of side walls rising from the bottom plate, and
a portion of the housing part opposed to a predetermined side wall coupled with the lid part via the hinge part has an opening.

13. The housing case for a recording medium built-in cartridge according to claim 12,
wherein a plurality of concavities are formed in the bottom plate, and
a longitudinal direction of a convex portion formed in the bottom plate as a result of the formation of the plurality of concavities is orthogonal to a longitudinal direction of the hinge part.

14. The housing case for a recording medium built-in cartridge according to claim 13, comprising a plurality of the humidity control members, wherein the plurality of humidity control members are disposed so that the plurality of concavities contain the respective humidity control members.

15. A cartridge built-in package, comprising the housing case for a recording medium built-in cartridge according to claim 1, wherein the recording medium built-in cartridge having the air vent is housed in the housing case.

16. The cartridge built-in package according to claim 15,
wherein the recording medium built-in cartridge comprises a case and a recording medium housed in the case, and
the air vent is formed in the case.

17. The cartridge built-in package according to claim 16, wherein the recording medium is a magnetic tape.

18. The cartridge built-in package according to claim 16, wherein a humidity in the case of the recording medium built-in cartridge is within a range more than 30% and less than 90% at a temperature from 10° C. to 60° C.

19. The cartridge built-in package according to claim 16, wherein a humidity in the case of the recording medium built-in cartridge is within a range more than 40% and less than 80% at a temperature from 10° C. to 60°0 C.
